(19) United States
(12) Patent Application Publication
(10) Pub. No.: US 2025/0022012 A1
(43) Pub. Date: Jan. 16, 2025

(54) SYSTEM AND METHOD FOR NON-PARAMETRIC BID-FLOOR OPTIMIZATION IN AUCTIONS AND APPLICATIONS THEREOF

(71) Applicant: YAHOO ASSETS LLC, New York, NY (US)

(72) Inventors: Boris Kapchits, Yoqneam Ilit (IL); Miguel Alcobendas, Westminster, CA (US); Jonathan Ji, Aldie, VA (US)

(21) Appl. No.: 18/351,939

(22) Filed: Jul. 13, 2023

(51) Int. Cl. G06Q 30/0273

(52) U.S. Cl. CPC G06Q 30/0275

(57) ABSTRACT

The present teaching relates to method, system, medium, and implementations for setting a dynamic bid floor. To conduct a bidding process for an ad opportunity to display an ad at a current placement venue, a dynamic bid floor is determined in a non-parametric manner to maximize revenue based on bid-floor (BF)/revenue dependency information. The dynamic bid floor is used to control the bidding process. A winning bid is selected from multiple bids received during the bidding and a corresponding winning advertisement is displayed at the placement venue.

### BACKGROUND

### 1. Technical Field

The present teaching generally relates to computers. More specifically, the present teaching relates to data analytics and application thereof.

### 2. Technical Background

With the advancement of the Internet, most people in the society now conduct their daily affairs online, including consuming different types of content (articles or videos), checking out different products, making purchases of just about everything, enjoying entertainment, receiving/providing education, or even taking virtual vacations. Such a shift in social behavior has motivated most entities, including individuals, companies, organizations, universities, or interest groups, to place a tremendous amount of information on the Internet. In the meantime, online content providers utilize their platforms to auction advertising opportunities to seek financial return. FIG. 1 illustrates an online ad spot auction framework 100, where a content provider 110 may utilize their online platform to act as an ad opportunity auctioneer to solicit bids on a vacant display spot 130-2 on a webpage 130-1 that the content provider 110 is to display to an online user. The solicitation may be sent to a plurality of bidders 150 via a network 140 and bids. Upon receiving the bids from bidders 150 via the network 140, the ad opportunity auctioneer 110 may select a winning bid based on various parameters stored in a storage 120. The webpage is then displayed to the user with an advertisement 160-2 associated with the winning bid on the displayed webpage 160.

In selecting a winning bid, the ad opportunity auctioneer 110 may consider different factors in different aspects of the advertising. FIG. 2A illustrates different types of bidding control parameters which may be stored in 120 and utilized in determining a winning bid. For example, the bidding parameters may include bid-floor, winner selection criterion, . . . , and budget involved in the campaign. The bid-floor may refer to the lowest bid that the ad opportunity auctioneer 100 will consider. That is, any bid that is lower than the bid-floor will not be considered. The winner selection criterion may correspond to an optimization scheme used in determining a winner. In some situations, the selection criterion may be defined to maximize the click-through rate (CTR) so that a bid with an advertisement that has a maximum estimated CTR may be selected. Such a selection criterion may also be defined to be conversion rate (CVR) so that a bid is selected when the corresponding advertisement has a maximal estimated CVR. In some bidding scheme, the auctioneer may have some set budget, which may be set on an overall level or at each campaign level so that the selection may need to meet the preset budget.

The bid-floor has been used to force higher bids that defines the lowest bid that can be accepted. During the bidding process, the bid-floor is communicated to all bidders in real time as part of the bidding request. Determining an optimal bid floor may be a complicated task. Choosing a value too low may lead to lower bids, causing revenue loss. On the other hand, if the bid-floor is set too high, the bidders may choose not to bid at all, also causing loss of revenue. In some processes, the bid-floor may be set as a static value and other processes, the bid-floor may be dynamically changed using some parametric models. A static bid-floor is inflexible in terms of changes in the advertising marketplace. A parametric-model based bid-floor modeling may be computationally burdensome in real-time and may not capture the changing situation associated with the market.

Thus, there is a need for a solution that addresses the issues discussed above.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for setting a dynamic bid floor. To conduct a bidding process for an ad opportunity to display an ad at a current placement venue, a dynamic bid floor is determined in a non-parametric manner to maximize revenue based on bid-floor (BF)/revenue dependency information. The dynamic bid floor is used to control the bidding process. A winning bid is selected from multiple bids received during the bidding and a corresponding winning advertisement is displayed at the placement venue.

In a different example, a system is disclosed for setting a dynamic bid floor. The disclosed system includes an auction interface engine and a non-parametric dynamic bid floor (BF) determiner. The auction interface engine is provided for conducting a bidding process to select a winning bid with respect to a placement venue to display a corresponding winning advertisement at a placement venue. The non-parametric BF is provided for dynamically determining a dynamic bid floor in a non-parametric manner that maximizes revenue with respect to the placement venue based on BF/revenue dependency information. The auction interface engine controls the bidding process based on the dynamic bid floor. When bids are received, the auction interface engine selects a winning bid based on some pre-determined selection criterion and then displays the corresponding winning advertisement associated with the winning bid at the placement venue.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for setting a dynamic bid floor. The information, when read by the machine, causes the machine to perform various steps. To conduct a bidding process for an ad opportunity to display an ad at a current placement venue, a dynamic bid floor is determined in a non-parametric manner to maximize revenue based on bid-floor (BF)/revenue dependency information. The dynamic bid floor is used to control the bidding process. A winning bid is selected from multiple bids received during the bidding and a corresponding winning advertisement is displayed at the placement venue.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an ad opportunity bidding framework for online advertising;

FIG. 2A illustrates different types of bidding control parameters;

FIG. 2B illustrates different types of way to setting up a bid-floor value;

FIG. 3 depicts an exemplary high-level system diagram of an ad opportunity auctioneer, in accordance with an embodiment of the present teaching;

FIGS. 4A-4B illustrate exemplary organizations of bid-floor/revenue dependency information with accumulated revenues corresponding to different bid floor values with respect to each advertisement placement identifier, in accordance with an embodiment of the present teaching;

FIG. 5A is a flowchart of an exemplary process of establishing a table of bid-floor/revenue dependency information, in accordance with an embodiment of the present teaching;

FIG. 5B is a flowchart of an exemplary process using bid-floor/revenue dependency information to dynamically determine a bid-floor in a non-parametric manner to maximize revenue, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

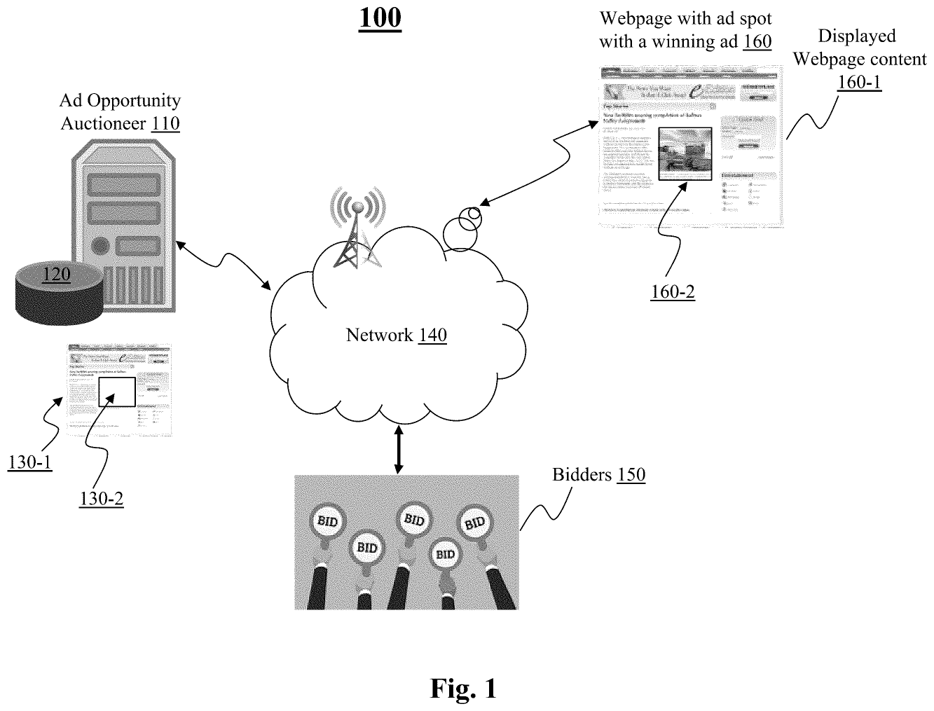

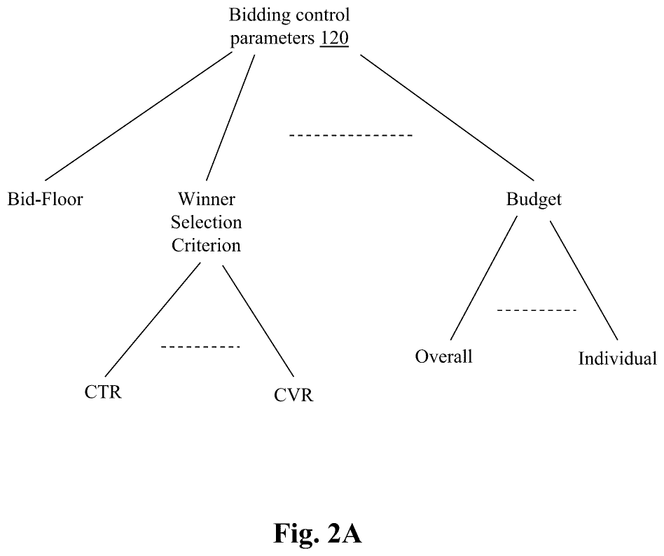

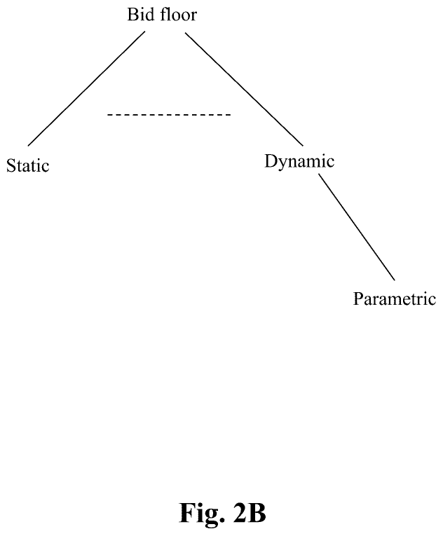

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses an exemplary framework for dynamically optimizing a bid-floor value in a non-parametric manner to maximize revenue. To support the optimization operation, a bid-floor/revenue dependency information is established with respect to each placement identification associated with a venue to display advertisements. Such dependency information may be updated with time so that it captures the characteristics of the relationship between bid-floor values and revenue with respect to each ad-display locale at different times/seasons. Based on such dependency information, with respect to each placement identifier associated with an ad placement venue, a bid-floor value may be selected that maximizes the average revenue at the placement venue. In some embodiments, the revenue may be defined based on application needs. In some applications, CTR may be sought so that the revenue may be determined based on CTR data collected with respect to previously displayed advertisements at each placement. In some applications, what is valued may be the conversion rate CVR and in this case, revenue associated with each bid-floor at each placement venue may be computed based on CVR data collected.

In some embodiments, the bid-floor/revenue dependency may be captured in a tabulated form so that in an optimized bid-floor value may be determined in a dynamic operation in a non-parametric manner, which is more efficient and direct. As discussed herein, the bid-floor/revenue dependency information may be adapted when needed so that it provides dynamic information that reflects the changing situation. This non-parametric approach to optimizing the bid-floor to maximize revenue defined based on application needs facilitates a direct, straightforward, efficient, and adaptive approach to dynamic selection of a bid-floor with respect to each placement venue.

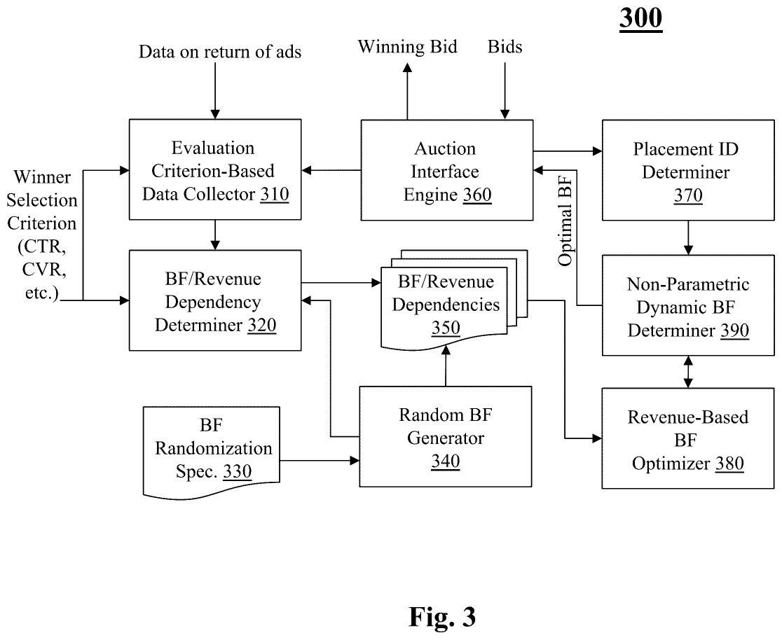

FIG. 3 depicts an exemplary high-level system diagram of an ad opportunity auctioneer 300 that selecting a winning bid based on a bid-floor selected in a non-parametric manner, in accordance with an embodiment of the present teaching. In this illustrated embodiment, the ad opportunity auctioneer 300 includes two parts, one for establishing bid-floor/revenue dependency information and the other part for using such established dependency information to select a bid-floor in a bidding process involving a given placement identifier by optimizing the average revenue according to the dependency information. The result of the first part is BF/revenue dependencies 350, which describe the correspondences between different bid-floor values used in prior bidding processes in connection with each placement venue and the corresponding revenue data associated with the display advertisements from such bidding processes. The revenue data may be collected according to what is defined as financial return, which may be CTR or CVR.

Based on the BF/revenue dependencies 350, the second part is for controlling a bidding process with respect to each placement venue. Given an identifier representing each placement venue, different bid-floor values associated therewith may be identified from the BF/revenue dependencies 350. Each of the bid-floor values associated with the given placement identifier, there may be multiple pieces of revenue information from different bidding processes. An aggregated revenue, e.g., an average revenue, with respect each bid-floor value may then be computed. Such aggregated revenues corresponding to different bid-floor values may then be evaluated to select an optimized bid-floor value that gives a maximum aggregated revenue.

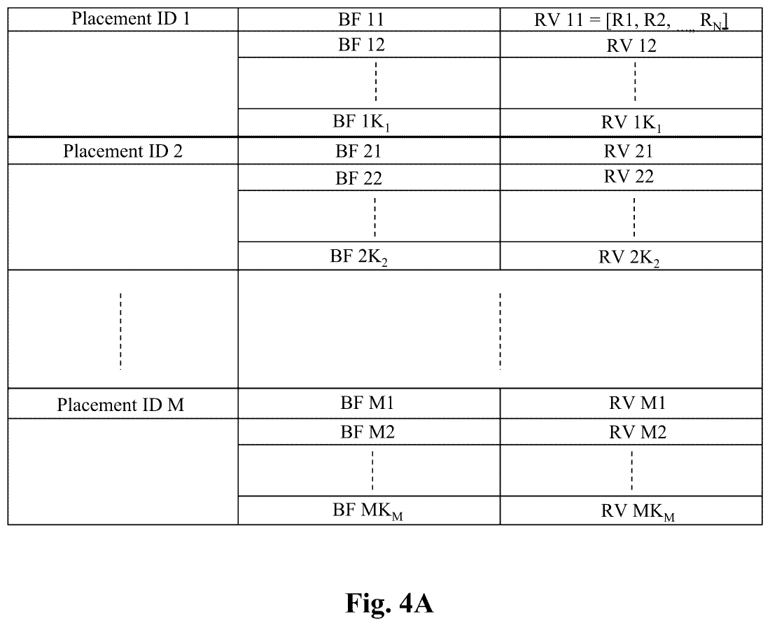

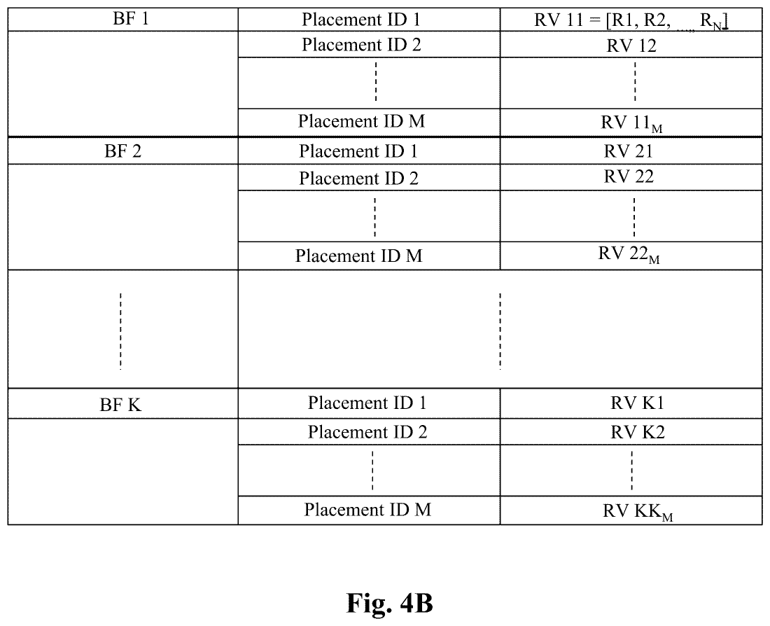

In some embodiments, the BF/revenue dependencies 350 may be organized as a table. FIGS. 4A and 4B illustrate exemplary alternative constructs for relevant dependency information extracted from collected online data to facilitate selecting an optimized bid-floor value, in accordance with embodiments of the present teaching. FIG. 4A shows a table organized based on placement identifiers and then different bid-floor values under each placement ID with various feedback revenue information with respect to each bid-floor value. As seen, with respect to each placement ID, there may be multiple BF values applied previously in bidding processes. For instance, for placement ID 1, there are BF11, BF12, . . . , BF1K₁; for placement ID 2, there are BF11, BF22, . . . , BF2K₂; . . . , for placement ID M, there are BFM1, BFM2, . . . , BFM_{KM}.

Corresponding to each bid floor value under each placement ID, there may be a set of collected revenues from advertisements displayed at placement ID and selected in bidding processed based on bid-floor value BF11. As illustrated in FIG. 4A, with respect to placement ID 1 and BF 11, RV11 is a set of collected revenues [R1, R2, R3, . . . , R_{K}] detected on winning advertisements displayed at placement ID 1 and selected in bidding processes using BF11. Based on such information, in a subsequent bidding processing with respect to placement ID 1, a bid floor value may be selected from BF11, BF12, . . . , BF1K₁, that maximizes the revenue, determined based on, e.g., the average revenues corresponding to different BF values (BF11, BF12, . . . , BF1K₁). With this representation, the number of BF values used at each placement ID may differ.

FIG. 4B shows an alternative construct for BF/revenue dependency information, in accordance with an embodiment of the present teaching. In this example, the construct may organize information according to BF values, e.g., . . . , BF 1, BF 2, . . . , BF K. Under each BF value, different placement IDs may be applicable, i.e., each BF value may be used in biddings with respect to different placement IDs. With respect to each combination of BF value and placement ID, there may be a set of revenues, collected with respect to different advertisements displayed at the placement ID and selected as a winner in the bidding process with the BF value. Based on this construct for BF/revenue dependency information, in a bidding process involving a specific placement, e.g., placement ID 1, with respect to each of BF values, return revenues collected on advertisements displayed at placement ID 1 and selected using the respective BF value may be averaged and an optimized BF value is selected as the bid-floor value used in the process to maximize the return.

Referring to FIG. 3, in this illustrated embodiment, the first part includes an evaluation criterion-based data collector 310, a bid-floor (BF)/revenue dependency determiner 320, and a random BF generator 340. The evaluation criterion-based data collector 310 is provided for collecting return revenue information on advertisements displayed at different placement venues. As discussed herein, the collected information is used to establish the BF/revenue dependency information to facilitate the BF optimization in subsequent bidding processes. Given that, the type of revenue data to be collected may be directed to type of return information relevant to each application that applied the present teaching. For instance, advertisers in some situations may seek to maximize CTR, in which case, information to be collected on return may be directed to click related information. In some situations, advertisers may desire to maximize CVR, in which case the information to be collected by the evaluation criterion-based data collector 310 may collect conversion rate information on the display advertisements.

The random BF generator 330 may be provided to generate, randomly according to some randomization scheme as specified in 330, different bid floor values. Such randomly generated BF values may be used to collect data and establish dependency relations between BF values and return revenues. For instance, the randomly generated BF values may be used to guide the evaluation criterion-based data collector 310 to gather return revenue information with respect to those winning advertisements displayed at certain placement venue and selected based on one of the randomly generated BF values. The BF values are also used by the BF/revenue dependency determine 320 as base data points to establish BF/revenue dependencies based on collected return revenue data to populate the construct (such as table(s)) for such BF/revenue dependency information 350. The generated dependency information may then be used by the second part of the ad opportunity auctioneer 110 in a subsequent bidding process to optimize the selection of a BF value with respect to a given placement venue.

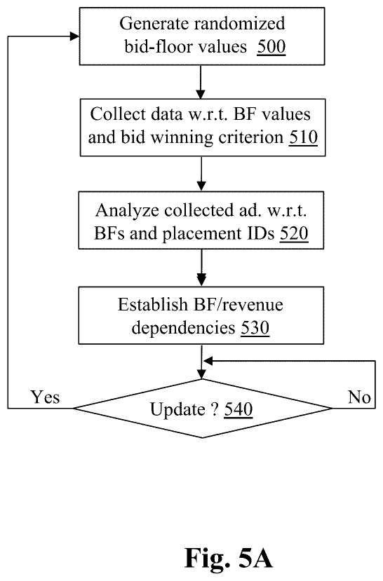

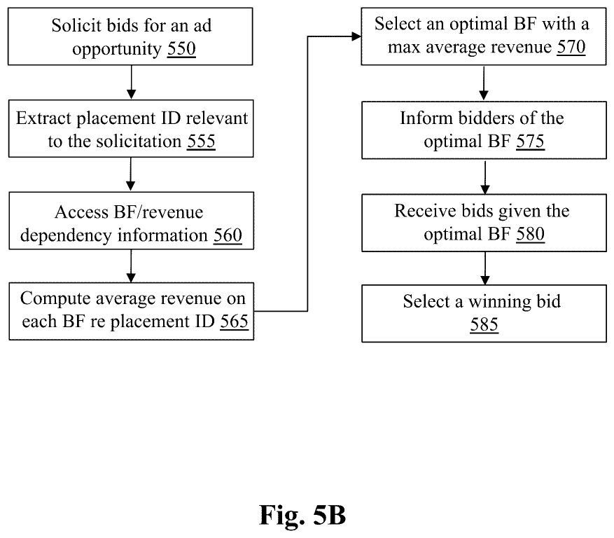

FIG. 5A is a flowchart of an exemplary process for establishing bid-floor/revenue dependency information, in accordance with an embodiment of the present teaching. In operation, the random BF generator 340 randomly generates, at 500, BF values according to some specified randomization scheme. Such information may then be used by the evaluation criterion-based data collector 310 to collect, at 510, return revenues (defined based on some specified financial criterion) on advertisements selected from bidding processes using relevant bid floor values and with respect to different placement venues. Based on the collected data, the BF/revenue dependency determiner 320 analyzes, at 520, the data to establish relationships among BFs, revenues, and placement venues to establish, at 530, the BF/revenue dependencies 350. Such established BF/revenue dependencies may be adapted dynamically in time so that the information to be used for selecting an optimized BF value reflects the actual information. The update may be set up according to a schedule or may be activated according to a need. When it is determined, at 540, that an update is needed, the process returns to step 500, as shown in FIG. 5A.

As discussed herein, the second part of the ad opportunity auctioneer 110 is to utilize the established BF/revenue dependencies 350 in a subsequent bidding process to dynamically select a bid floor by maximizing the revenue. In the illustrated embodiment shown in FIG. 3, the second part of the ad opportunity auctioneer 110 comprises an auction interface engine 360, a placement ID determiner 370, a non-parametric dynamic BF determiner 380, and a revenue-based BF optimizer 390. The auction interface engine 360 is provided for interacting with bidders during a bidding process, such as soliciting bids, announcing a bid floor to bidders, receiving bids, selecting a winning bid, and communicating a winning bid to the bidders. The placement ID determiner 370 is provided to identify the identifier of a placement venue related to each bidding process. The non-parametric dynamic BF determiner 380 is provided to control the dynamic determination of an optimal BF value given a placement ID via the interaction with the revenue-based BF optimizer 390, that selects an optimized BF value based on the BF/revenue dependencies 350.

FIG. 5B is a flowchart of an exemplary process of the second part of the ad opportunity auctioneer 110 in which a bid-floor is dynamically determined in a non-parametric manner to maximize revenue, in accordance with an embodiment of the present teaching. The auction interface engine 360 may first solicit, at 550, bids from a plurality of bidders with respect to an ad opportunity associated with a placement venue. The placement ID determiner 370 extracts, at 555, the placement ID associated with the solicitation and activates the non-parametric dynamic BF determiner 380 to initiate the algorithm to determine a bid floor in a non-parametric manner. The non-parametric dynamic determiner 380 may invoke the revenue-based BF optimizer 390 with the placement ID to generate an optimized bid floor. Upon receiving the placement ID associated with the bidding process, the revenue-based BF optimizer 390 accesses, at 560, the established BF/revenue dependency information in 350 and computes, at 565, average revenue with respect each of BF values associated with the placement ID. Based on such computed average revenues for different BF values, an optimal bid floor is selected, at 570, as the BF that corresponds to a maximum average revenue and sent to the non-parametric dynamic BF determiner 380. The optimized bid floor for the placement ID is then sent to the auction interface engine 360, which informs, at 575, the bidders of the bid floor for this bidding process.

Based on the bid floor communicated to the bidders, the bidders send bids that satisfy the bid floor. Upon receiving, at 580, the bids, the auction interface engine 360 selects, at 585, a winning bid based on pre-configured selection criteria, which concludes the bidding process. Information about the winning bid may then be used to display the winning advertisement at the placement venue. To support continuous update of the BF/revenue dependencies, such winning bid may also be sent to the evaluation criterion-based data collector 310 to track the return revenue of the advertisement associated with the winning bid to enable adaptation of the BF/revenue dependencies 350 based on on-going revenue information. The non-parametric approach to determining dynamic optimized bid floors according to the present teaching is efficient and adaptive in terms of both placement venue and time.

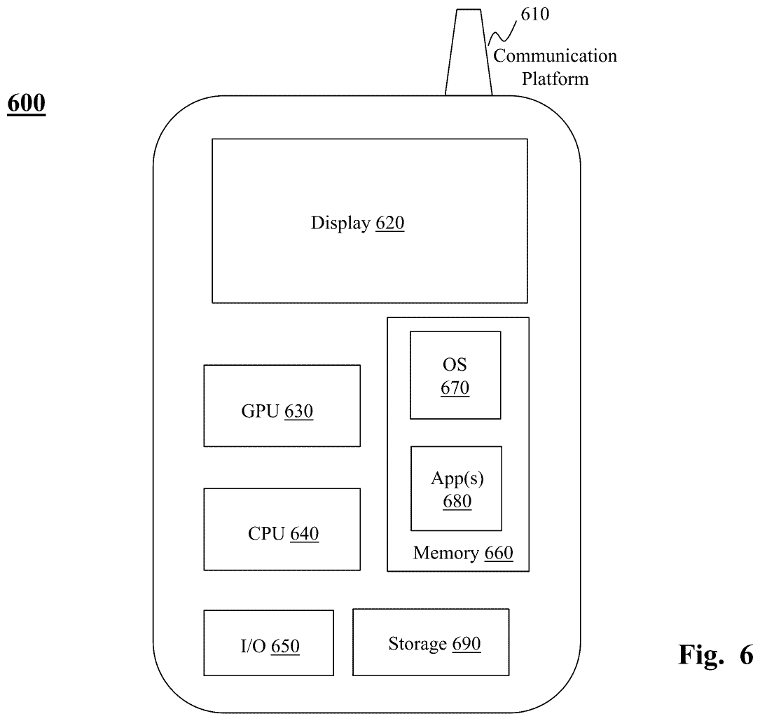

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 700. As shown in FIG. 6, a mobile operating system 670 (e.g., iOS, Android, Windows Phone, etc.), and one or more applications 680 may be loaded into memory 660 from storage 690 in order to be executed by the CPU 640. The applications 680 may include a user interface or any other suitable mobile apps for information analytics and management according to the present teaching on, at least partially, the mobile device 600. User interactions, if any, may be achieved via the I/O devices 650 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

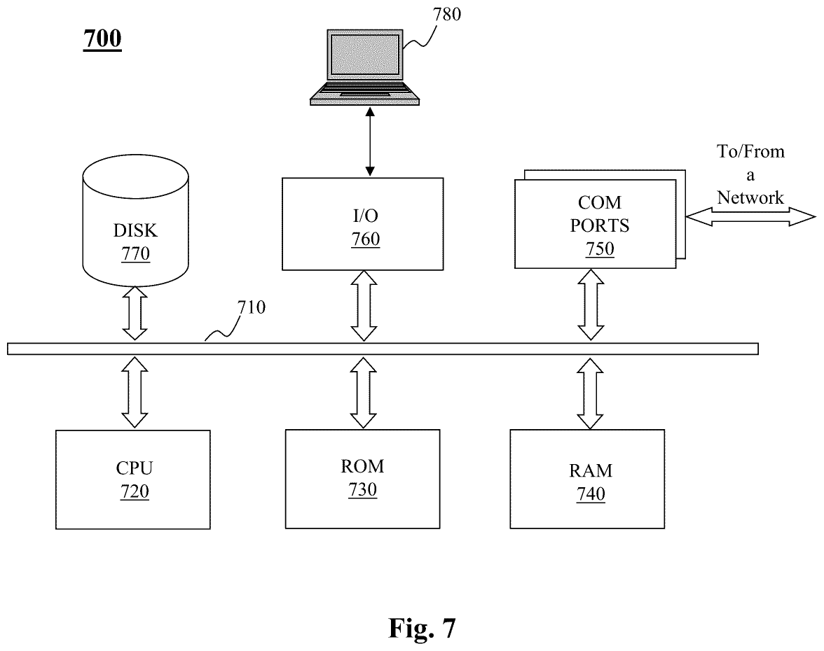

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for setting a dynamic bid floor, comprising:
receiving information indicating an opportunity to display an advertisement at a current placement venue;
dynamically determining, for a bidding process for selecting a winning advertisement to be displayed at the current placement venue, a dynamic bid floor in a non-parametric manner that maximizes revenue with respect to the current placement venue based on bid-floor (BF)/revenue dependency information;
soliciting, with the dynamic bid floor, bids from a plurality of bidders for selecting the winning advertisement for the current placement venue;
receiving multiple bids from some of the plurality of bidders;
selecting a winning bid from the multiple bids in accordance with some pre-determined selection criterion, wherein the winning advertisement is associated with the winning bid; and
displaying, at the current placement venue, the winning advertisement.

2. The method of claim 1, wherein the BF/revenue dependency information is previously established based on return revenues tracked with respect to different advertisements previously displayed at different placement venues, wherein each of the tracked advertisements is selected in a bidding process using a corresponding bid-floor.

3. The method of claim 2, wherein the BF/revenue dependency information is established by:
collecting return revenues with respect to the different advertisements;
analyzing the collected return revenues to associate each return revenue with a corresponding bid floor applied in a bidding process and a corresponding placement venue where the advertisement corresponding to the return revenue is previously displayed;
generating a representation of BF/revenue dependencies that is indicative of relationships among the collected return revenues, corresponding bid floors, and corresponding placement venues.

4. The method of claim 3, wherein the representation of the BF/revenue dependencies includes:
bid floors used in bidding processes in association with each of the placement venues; and
return revenues tracked from advertisements selected in corresponding bidding processes using each of the bid floors with respect to each of the placement venues.

5. The method of claim 4, wherein the step of dynamically determining comprises:
accessing the BF/revenue dependency information;
identifying relevant bid floors associated with the current placement venue in the BF/revenue dependency information;
computing, with respect to each of the relevant bid floors, a representative revenue of the relevant bid floor based on return revenues associated therewith; and
selecting one of the representative revenues that has a maximum representative revenue as the dynamic bid floor for the current placement venue.

6. The method of claim 5, wherein the representative revenue of each of the relevant bid floors is determined by averaging the return revenues associated with the relevant bid floor.

7. The method of claim 1, further comprising:
recording the dynamic bid floor used in selecting the winning advertisement;
tracking new return revenue of the winning advertisement after it is displayed at the current placement venue; and
updating the BF/revenue dependency information based on the dynamic bid floor applied for the current placement venue and the new return revenue of the winning advertisement.

8. Machine readable and non-transitory medium having information recorded thereon for setting a dynamic bid floor, wherein the information, when read by the machine, causes the machine to perform the following steps:
receiving information indicating an opportunity to display an advertisement at a current placement venue;
dynamically determining, for a bidding process for selecting a winning advertisement to be displayed at the current placement venue, a dynamic bid floor in a non-parametric manner that maximizes revenue with respect to the current placement venue based on bid-floor (BF)/revenue dependency information;
soliciting, with the dynamic bid floor, bids from a plurality of bidders for selecting the winning advertisement for the current placement venue;
receiving multiple bids from some of the plurality of bidders;
selecting a winning bid from the multiple bids in accordance with some pre-determined selection criterion, wherein the winning advertisement is associated with the winning bid; and
displaying, at the current placement venue, the winning advertisement.

9. The medium of claim 8, wherein the BF/revenue dependency information is previously established based on return revenues tracked with respect to different advertisements previously displayed at different placement venues, wherein each of the tracked advertisements is selected in a bidding process using a corresponding bid-floor.

10. The medium of claim 9, wherein the BF/revenue dependency information is established by:
collecting return revenues with respect to the different advertisements;
analyzing the collected return revenues to associate each return revenue with a corresponding bid floor applied in a bidding process and a corresponding placement venue where the advertisement corresponding to the return revenue is previously displayed;
generating a representation of BF/revenue dependencies that is indicative of relationships among the collected return revenues, corresponding bid floors, and corresponding placement venues.

11. The medium of claim 10, wherein the representation of the BF/revenue dependencies includes:
bid floors used in bidding processes in association with each of the placement venues; and
return revenues tracked from advertisements selected in corresponding bidding processes using each of the bid floors with respect to each of the placement venues.

12. The medium of claim 11, wherein the step of dynamically determining comprises:
accessing the BF/revenue dependency information;
identifying relevant bid floors associated with the current placement venue in the BF/revenue dependency information;
computing, with respect to each of the relevant bid floors, a representative revenue of the relevant bid floor based on return revenues associated therewith; and
selecting one of the representative revenues that has a maximum representative revenue as the dynamic bid floor for the current placement venue.

13. The medium of claim 12, wherein the representative revenue of each of the relevant bid floors is determined by averaging the return revenues associated with the relevant bid floor.

14. The medium of claim 8, wherein the information, when read by the machine, further causes the machine to perform the steps of:
recording the dynamic bid floor used in selecting the winning advertisement;
tracking new return revenue of the winning advertisement after it is displayed at the current placement venue; and
updating the BF/revenue dependency information based on the dynamic bid floor applied for the current placement venue and the new return revenue of the winning advertisement.

15. A system for setting a dynamic bid floor, comprising:
an auction interface engine implemented by a processor and configured for receiving information indicating an opportunity to display an advertisement at a current placement venue; and
a non-parametric dynamic bid floor (BF) determiner implemented by a processor and configured for dynamically determining, for a bidding process for selecting a winning advertisement to be displayed at the current placement venue, a dynamic bid floor in a non-parametric manner that maximizes revenue with respect to the current placement venue based on BF/revenue dependency information, wherein
the auction interface engine is further configured for
soliciting, with the dynamic bid floor, bids from a plurality of bidders for selecting the winning advertisement for the current placement venue,
receiving multiple bids from some of the plurality of bidders,
selecting a winning bid from the multiple bids in accordance with some pre-determined selection criterion, wherein the winning advertisement is associated with the winning bid, and
displaying, at the current placement venue, the winning advertisement.

16. The system of claim 15, wherein the BF/revenue dependency information is previously established based on return revenues tracked with respect to different advertisements previously displayed at different placement venues, wherein each of the tracked advertisements is selected in a bidding process using a corresponding bid-floor.

17. The system of claim 16, wherein the BF/revenue dependency information is established by:
collecting return revenues with respect to the different advertisements;
analyzing the collected return revenues to associate each return revenue with a corresponding bid floor applied in a bidding process and a corresponding placement venue where the advertisement corresponding to the return revenue is previously displayed;
generating a representation of BF/revenue dependencies that is indicative of relationships among the collected return revenues, corresponding bid floors, and corresponding placement venues.

18. The system of claim 17, wherein the representation of the BF/revenue dependencies includes:
bid floors used in bidding processes in association with each of the placement venues; and
return revenues tracked from advertisements selected in corresponding bidding processes using each of the bid floors with respect to each of the placement venues.

19. The system of claim 18, wherein the step of dynamically determining comprises:
accessing the BF/revenue dependency information;
identifying relevant bid floors associated with the current placement venue in the BF/revenue dependency information;
computing, with respect to each of the relevant bid floors, a representative revenue of the relevant bid floor based on return revenues associated therewith; and
selecting one of the representative revenues that has a maximum representative revenue as the dynamic bid floor for the current placement venue.

20. The system of claim 15, further comprising an evaluation criterion-based data collector implemented by a processor and configured for:
recording the dynamic bid floor used in selecting the winning advertisement;
tracking new return revenue of the winning advertisement after it is displayed at the current placement venue; and
updating the BF/revenue dependency information based on the dynamic bid floor applied for the current placement venue and the new return revenue of the winning advertisement.
